(19) United States
(12) Patent Application Publication
(10) Pub. No.: US 2025/0167848 A1
(43) Pub. Date: May 22, 2025

(54) USER EQUIPMENT CAPABILITY INFORMATION FOR ENHANCED CHANNEL STATE INFORMATION REPORTING

(71) Applicant: Apple Inc., Cupertino, CA (US)

(72) Inventors: Haitong Sun, Cupertino, CA (US); Hong He, San Jose, CA (US); Dawei Zhang, Saratoga, CA (US); Wei Zeng, Saratoga, CA (US); Yushu Zhang, Beijing (CN); Chunxuan Ye, San Diego, CA (US); Weidong Yang, San Diego, CA (US)

(21) Appl. No.: 18/836,451

(22) PCT Filed: Feb. 11, 2022
(86) PCT No.: PCT/CN2022/075991

§ 371 Date: Aug. 7, 2024

(51) Int. Cl. H04B 7/06; H04L 5/00; H04W 72/232

(52) U.S. Cl. CPC H04B 7/0626; H04L 5/0048; H04W 72/232

(57) ABSTRACT

Systems and methods for transmitting and receiving user equipment (UE) capability information. A UE includes a transceiver and a processor. The processor is configured to receive, via the transceiver, a UE capability request. The processor is also configured to transmit, via the transceiver and in response to the UE capability request, UE capability information for 3rd Generation Partnership Project (3GPP) new radio (NR) Release 17 (Rel-17) enhanced channel state information (CSI) reporting for a single downlink control information (DCI) multiple transmission and reception point (Multi-TRP) non-coherent joint transmission (NCJT) scheme.

### CROSS-REFERENCE TO RELATED APPLICATION

This application is a 35 U.S.C. § 371 application of PCT/CN2022/075991, filed on Feb. 11, 2022, and entitled “USER EQUIPMENT CAPABILITY INFORMATION FOR ENHANCED CHANNEL STATE INFORMATION REPORTING,” which is incorporated herein by reference as if fully disclosed herein.

### TECHNICAL FIELD

This application relates generally to wireless communication systems, including the transmission of user equipment (UE) capability information for 3rd Generation Partnership Project (3GPP) new radio (NR) Release 17 (Rel-17) enhanced channel state information (CSI) reporting.

### BACKGROUND

Wireless mobile communication technology uses various standards and protocols to transmit data between a base station and a wireless communication device. Wireless communication system standards and protocols can include, for example, 3GPP long term evolution (LTE) (e.g., 4G), 3GPP NR (e.g., 5G), and IEEE 802.11 standard for wireless local area networks (WLAN) (commonly known to industry groups as Wi-Fix).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example flow diagram for transmitting UE capability information from a UE to a network.

FIG. 2 shows an example method of a UE, which method may be used to transmit UE capability information to a network in accord with the flow diagram described with reference to FIG. 1.

FIG. 3 shows an example method of a network, which method may be used to receive UE capability information from a UE in accord with the flow diagram described with reference to FIG. 1.

FIG. 4 illustrates an example architecture of a wireless communication system, according to embodiments disclosed herein.

FIG. 5 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

3GPP Release 16 (Rel-16) defines six multiple transmission and reception point (Multi-TRP) schemes without channel state information (CSI) enhancement. The six schemes are a multiple downlink control information (multi-DCI) Multi-TRP scheme; a single DCI Multi-TRP scheme 1a (a spatial domain multiplexing (SDM) scheme, also referred to as a single DCI Multi-TRP non-coherent joint transmission (NCJT) scheme); a single DCI Multi-TRP fdmSchemeA (scheme 2a, a first frequency domain multiplexing (FDM) scheme); a single DCI Multi-TRP fdmSchemeB (scheme 2b, a second FDM scheme); a single DCI Multi-TRP tdmSchemeA (scheme 3, a time domain multiplexing (TDM) scheme); and a single DCI Multi-TRP inter-slot physical downlink shared channel (PDSCH) repetition scheme (scheme 4).

3GPP NR Rel-17 defines a CSI enhancement for the single DCI Multi-TRP scheme 1a (or NCJT scheme). The single DCI Multi-TRP scheme 1a allows a single DCI transmission (i.e., a transmission from one TRP) to schedule a transport block (TB) with up to four layers transmitted from two TRPs. Each of the two TRPs may transmit up to two layers, with layer splits of (1, 1), (1, 2), (2, 1), and (2, 2) being supported by the two TRPs. The DCI field “Transmission Configuration Indication” (TCI) may indicate two TCI states. The DCI field “Antenna Port(s)” may indicate two demodulation reference signal (DMRS) code division multiplexing (CDM) groups without data. The 3GPP NR Rel-17 CSI enhancement supports only ‘typeI-SinglePanel’ transmissions.

For 3GPP NR Rel-17 enhanced CSI reporting, each CSI configuration report (i.e., CSI-ReportConfig) is associated/configured with a single non-zero parameter (NZP)-CSI-RS resource set (i.e., an NZP CSI-RS-ResourceSet) for channel measurement resource (CMR) selection, but the single NZP CSI-RS resource set is divided into three groups of NZP CSI-RS resources. Resource group 1 contains up to K₁ NZP CSI-RS resources for a Single-TRP (the first TRP in a Multi-TRP scheme), and resource group 2 contains up to K₂ NZP CSI-RS resources for a Single-TRP (the second TRP in a Multi-TRP scheme). The following relationship is maintained:

$$1 \leq {K}_{s} = {K}_{1} + {K}_{2} \leq 8 , {k}_{1} \geq 1 , {k}_{2} \geq 1$$

The third resource group includes N pairs of NZP CSI-RS resources for a Multi-TRP NCJT scheme, where N∈{1, 2}. Each resource in the pair is selected from the K₁+K₂ resources configured for Single-TRPs (e.g., one resource from each of resource group 1 and resource group 2).

In addition, CMR sharing (i.e., “sharedCMR”) can be configured. When configured, N CMR pairs used for a Multi-TRP NCJT scheme can also be used for Single-TRP measurement.

3GPP NR Rel-17 supports two reporting modes for enhanced CSI reporting in a single DCI Multi-TRP NCJT scheme-Mode 1 and Mode 2. There are three different variants of Mode 1, each of which is indicated by a different value of X, where X∈{0, 1, 2}. For Mode 1 X=0, a UE only reports a best NCJT measurement hypothesis (e.g., a best NCJT or multi-TRP measurement hypothesis based on NZP CSI-RS measurements for pairs of resources). For Mode 1 X=1, a UE reports a best Single-TRP measurement hypothesis from among both TRPs, and also reports a best NCJT measurement hypothesis. For Mode 1 X=2, a UE reports a best Single-TRP measurement hypotheses for the first TRP, a best Single-TRP measurement hypothesis for the second TRP, and a best NCJT measurement hypothesis. For Mode 2 enhanced CSI reporting, a UE reports the best measurement hypothesis from among Single-TRP measurement hypotheses and NCJT measurement hypotheses.

Currently, there is no method for a network to obtain, from a UE, UE capability information for 3GPP NR Rel-17 enhanced CSI reporting for a single DCI Multi-TRP NCJT scheme. Described herein are methods for reporting and receiving UE capability information for 3GPP NR Rel-17 enhanced CSI reporting for a single DCI Multi-TRP NCJT scheme. The UE capability information may include information about CSI reporting capability, a number of active CSI-RS resources/ports that can be processed in a slot, a number of CPUs that can be processed, and/or a CSI report UE processing complexity envelope.

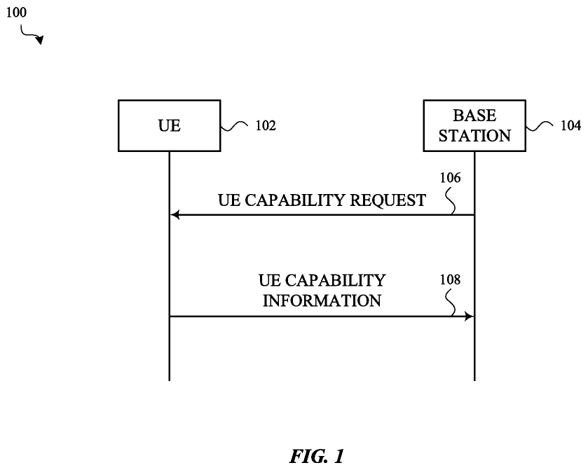

FIG. 1 shows an example flow diagram 100 for transmitting UE capability information from a UE 102 to a network 104 (e.g., to a RAN (e.g., a base station of a RAN) or a CN).

At 106, the network 104 may transmit a UE capability request to the UE 102. The UE capability may be transmitted in one or more radio resource control (RRC) messages.

At 108, the UE may respond to the UE capability request by transmitting UE capability information to the network 104. The UE capability information may be transmitted in one or more RRC messages. The UE capability information may include, for example, UE capability information for 3GPP NR Rel-17 enhanced CSI reporting for a single DCI Multi-TRP NCJT scheme.

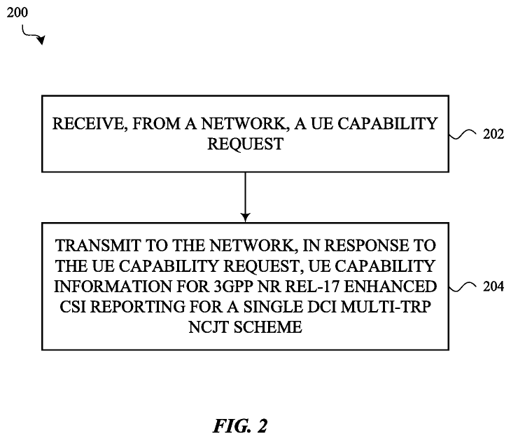

FIG. 2 shows an example method 200 of a UE, which method 200 may be used to transmit UE capability information to a network in accord with the flow diagram described with reference to FIG. 1.

At block 202, the method 200 may include receiving a UE capability request. The UE capability request may be received from a network (e.g., from a RAN (e.g., a base station of a RAN) or a CN).

At block 204, the method 200 may include transmitting to the network (e.g., to the RAN or the CN), in response to the UE capability request, UE capability information for 3GPP NR Rel-17 enhanced CSI reporting for a single DCI Multi-TRP NCJT scheme.

In accord with the method 200, the UE may include, in the UE capability information transmitted at 204, an indication of its CSI reporting capability. In some embodiments, UEs may independently report which one of the enhanced CSI reporting modes it supports, or the UE may independently report whether it supports each mode. For example, in some embodiments of the method 200, the UE capability information may include an indication of whether the UE supports an enhanced CSI reporting of Mode 1 X=0, Mode 1 X=1, Mode 1 X=2, or Mode 2 (e.g., the UE capability information may include a bitmap with a bit per mode to indicate whether the mode is supported). The UE may report whether it supports one of the modes Mode 1 X=0, Mode 1 X=1, Mode 1 X=2, or Mode 2, or may separately indicate each of the modes that it supports.

In some embodiments, UEs that support a Mode 1 X=n may be required to support all Mode 1 options with values of X≤n (e.g., support for modes with a lower value of X may be a prerequisite to supporting modes with a higher value of X). In these embodiments, the UE capability information may include an indication that the UE supports enhanced CSI reporting Mode 1 X=n, where n is an integer greater than or equal to zero, and the UE may be configured to support each enhanced CSI reporting Mode 1 X≤n. For example, if the UE supports Mode 1 X=1, the UE also has to support Mode 1 X=0. Similarly, if the UE supports Mode 1 X=2, the UE also has to support Mode 1 X=1 and Mode 1 X=0. In some cases, all UEs may be configured in this manner.

In some embodiments, UEs may have to support a value of X greater than zero. In these embodiments, the UE may be configured to support an enhanced CSI reporting Mode 1 X≥1, and the UE capability information may include an indication that the UE supports an enhanced CSI reporting Mode 1 X=n, where n≥1. In some cases, all UEs in a network may have to support values of X lower than n. In such embodiments, the UE may not need to support Mode 2.

In some embodiments, the UE may be configured to support only an enhanced CSI reporting Mode 1 X=0. In these embodiments, the UE capability information may include an indication that the maximum Kₛ supported by the UE is 0, where Kₛ=K₁+K₂, K is a number of NZP CSI-RS resources for a first Single-TRP measurement of a first TRP in the Multi-TRP, and K₂ is a number of NZP CSI-RS resources for a second Single-TRP measurement of a second TRP in the Multi-TRP. Stated differently, the indication that the maximum Kₛ supported by the UE is 0 may indicate that the UE does not support CSI-RS resources configured in the corresponding CSI-ReportConfig for Single-TRP measurements. In some embodiments, the UE may require all UEs to support only Mode 1 X=0, and the network may not configure resources for X=1 or Mode 1 X=2. This may simplify the CSI-RS resource configuration.

In some embodiments, UEs may be required to support either Mode 1 or Mode 2 as a basic feature. For example, if Mode 1 is the basic feature, a UE has to support Mode 1 before it can support Mode 2 (i.e., supporting Mode 1 is a prerequisite to supporting Mode 2). In these embodiments, and assuming that Mode 1 is a basic feature for UEs, the UE capability information may include an indication that the UE supports enhanced CSI reporting Mode 2, and transmission of the UE capability information including the indication that the UE supports enhanced CSI reporting Mode 2 indicates that the UE also supports at least one enhanced CSI reporting Mode 1 X=n (i.e., the basic feature).

In some embodiments, the UE capability information may include an indication that the UE supports enhanced CSI reporting, and transmission of the UE capability information including the indication that the UE supports an enhanced CSI reporting mode indicates that the UE supports at least one enhanced CSI reporting Mode 1 X=n in addition to enhanced CSI reporting Mode 2. In these embodiments, all UEs may be required to support at least one Mode 1 and Mode 2.

In 3GPP Rel-15 and Rel-16, a UE CSI processing complexity related capability is mainly captured by two indications: 1) a maximum number of active CSI-RS resources/ports that the UE can process in a slot, and 2) a maximum number of CPUs that the UE can process in a slot. For active CSI-RS resources/ports processing indication, the UE may report a supported maximum number of simultaneous NZP CSI-RS for active bandwidth parts that the UE may measure across all component carriers (e.g., maxNumberSimultaneousNZP-CSI-RS-ActBWP-AllCC), a total number of ports that are simultaneously supported for NZP CSI-RS measurement for active bandwidth parts across all component carriers (e.g., totalNumberPortsSimultaneousNZP-CSI-RS-ActBWP-AllCC), a supported maximum number of simultaneous NZP CSI-RS that may be measured per component carrier (e.g., maxNumberSimultaneousNZP-CSI-RS-PerCC), and a total number of ports that are simultaneously supported for NZP CSI-RS measurement per component carrier (e.g., totalNumberPortsSimultaneousNZP-CSI-RS-PerCC). 3GPP Technical Specification (TS) 38.214 states, for example:
In any slot, the UE is not expected to have more active CSI-RS ports or active CSI-RS resources in active BWPs than reported as capability. NZP CSI-RS resource is active in a duration of time defined as follows. For aperiodic CSI-RS, starting from the end of the PDCCH containing the request and ending at the end of the scheduled PUSCH containing the report associated with this aperiodic CSI-RS. When the PDCCH candidates are associated with a search space set configured with searchSpaceLinking, for the purpose of determining the NZP CSI-RS resource active duration, the PDCCH candidate that ends later in time among the two linked PDCCH candidates is used. For semi-persistent CSI-RS, starting from the end of when the activation command is applied, and ending at the end of when the deactivation command is applied. For periodic CSI-RS, starting when the periodic CSI-RS is configured by higher layer signalling, and ending when the periodic CSI-RS configuration is released. If a CSI-RS resource is referred N times by one or more CSI Reporting Settings, the CSI-RS resource and the CSI-RS ports within the CSI-RS resource are counted N times. For a CSI-RS Resource Set for channel measurement configured with two Resource Groups and N Resource Pairs, if a CSI-RS resource is referred X times by one of the M CSI-RS resources, where M is defined in clause 5.2.1.4.2, and/or one or two Resource Pairs, the CSI-RS resource and the CSI-RS ports within the CSI-RS resource are counted X times.

For CPU processing unit indication, the UE may report a supported maximum number of simultaneous CSI reports per component carrier (e.g., simultaneousCSI-ReportsPerCC) and a supported maximum number of simultaneous CSI reports across all component carriers (e.g., simultaneousCSI-ReportsAllCC). 3GPP TS 38.214 states, for example:
The UE indicates the number of supported simultaneous CSI calculations N_{CPU} with parameter simultaneousCSI-ReportsPerCC in a component carrier, and simultaneousCSI-ReportsAllCC across all component carriers. If a UE supports N_{CPU} simultaneous CSI calculations it is said to have N_{CPU} CSI processing units for processing CSI reports. If L CPUs are occupied for calculation of CSI reports in a given OFDM symbol, the UE has N_{CPU}−L unoccupied CPUs. If N CSI reports start occupying their respective CPUs on the same OFDM symbol on which N_{CPU}−L CPUs are unoccupied, where each CSI report n=0, . . . , N−1 corresponds to O_{CPU}⁽ⁿ⁾, the UE is not required to update the N−M requested CSI reports with lowest priority (according to Clause 5.2.5), where 0≤M≤N is the largest values such that Σₙ₌₀^{M-1}O_{CPU}⁽ⁿ⁾≤N_{CPU}−L holds.

In accord with the method 200, the UE may also or alternatively include, in the UE capability information transmitted at 204, an indication of the maximum number of active CSI-RS resources/ports it can process in a slot. In some embodiments, the maximum number of active CSI-RS resources/ports the UE can process in a slot may be jointly indicated for both 3GPP NR Rel-17 enhanced CSI reporting for a single DCI Multi-TRP NCJT scheme and 3GPP Rel-15/Rel-16 CSI reporting. For example, the 3GPP Rel-15/Rel-16 UE capability information for CSI reporting may also indicate the maximum number of active CSI-RS resources/ports supported by the UE for 3GPP NR Rel-17 enhanced CSI reporting for a single DCI Multi-TRP NCJT scheme. That is, the 3GPP Rel-15/Rel-16 UE capability information (e.g., maxNumberSimultaneousNZP-CSI-RS-ActBWP-AllCC, totalNumberPortsSimultaneousNZP-CSI-RS-ActBWP-AllCC, maxNumberSimultaneousNZP-CSI-RS-PerCC, and totalNumberPortsSimultaneousNZP-CSI-RS-PerCC) may also apply to 3GPP NR Rel-17 enhanced CSI reporting for a single DCI Multi-TRP NCJT scheme. In some cases, however, the enhanced CSI reporting indications may unduly limit the values of the CSI reporting indications, because the values of the enhanced CSI reporting indications may be lower than the values of the CSI reporting indications and, in such embodiments, there is no provision for separately indicating values for CSI reporting and enhanced CSI reporting.

In some embodiments of the method 200, the maximum number of active CSI-RS resources/ports the UE can process in a slot may be separately indicated for 3GPP NR Rel-17 enhanced CSI reporting for a single DCI Multi-TRP NCJT scheme and 3GPP Rel-15/Rel-16 CSI reporting. For example, the format of the 3GPP Rel-15/Rel-16 UE capability information may be used to separately indicate, in a new information element, set of information elements, or set of fields, the maximum number of active CSI-RS resources/ports supported by the UE for 3GPP NR Rel-17 enhanced CSI reporting for a single DCI Multi-TRP NCJT scheme. That is, the UE capability information transmitted at 204 may include new maxNumberSimultaneousNZP-CSI-RS-ActBWP-AllCC, totalNumberPortsSimultaneousNZP-CSI-RS-ActBWP-AllCC, maxNumberSimultaneousNZP-CSI-RS-PerCC, and totalNumberPortsSimultaneousNZP-CSI-RS-PerCC indications. In these embodiments, the 3GPP Rel-15/Rel-16 UE capability information for indicating the maximum number of active CSI-RS resources/ports supported by the UE may only apply to 3GPP Rel-15/Rel-16 CSI reporting, and the new UE capability information (for 3GPP NR Rel-17 enhanced CSI reporting for a single DCI Multi-TRP NCJT scheme) may only apply to enhanced CSI reporting. Alternatively, the new maxNumberSimultaneousNZP-CSI-RS-ActBWP-AllCC, totalNumberPortsSimultaneousNZP-CSI-RS-ActBWP-AllCC, maxNumberSimultaneousNZP-CSI-RS-PerCC, and totalNumberPortsSimultaneousNZP-CSI-RS-PerCC indications may be used to jointly indicate the maximum number of active CSI-RS resources/ports the UE can process in a slot for both 3GPP NR Rel-17 enhanced CSI reporting for a single DCI Multi-TRP NCJT scheme and 3GPP Rel-15/Rel-16 CSI reporting.

In some embodiments of the method 200, the maximum number of active CSI-RS resources/ports the UE can process in a slot may be indicated as at least one combination of a first maximum number of active CSI-RS resources/ports the UE can process in a slot for 3GPP NR Rel-17 enhanced CSI reporting for a single DCI Multi-TRP NCJT scheme, and a second maximum number of active CSI-RS resources/ports the UE can process in a slot, in combination with the first number, for 3GPP Rel-15/Rel-16 CSI reporting. A combination may be provided for each of new maxNumberSimultaneousNZP-CSI-RS-ActBWP-AllCC, totalNumberPortsSimultaneousNZP-CSI-RS-ActBWP-AllCC, maxNumberSimultaneousNZP-CSI-RS-PerCC, and totalNumberPortsSimultaneousNZP-CSI-RS-PerCC indications. For example, for a new maxNumberSimultaneousNZP-CSI-RS-ActBWP-AllCC indication, the UE may include, in the UE capability information transmitted at 204, the following list:
Maximum of 64 CSI-RS resource for Rel-15/16, and maximum of 0 CSI-RS resources for Rel-17;
Maximum of 48 CSI-RS resources for Rel-15/16, and maximum of 8 CSI-RS resources for Rel-17;
Maximum of 32 CSI-RS resources for Rel-15/16, and maximum of 16 CSI-RS resources for Rel-17;
Maximum of 16 CSI-RS resources for Rel-15/16, and maximum of 24 CSI-RS resources for Rel-17; and
Maximum of 0 CSI-RS resources for Rel-15/16, and maximum of 32 CSI-RS resources for Rel-17.

The above list shows that, in comparison to CSI reporting for 3GPP Rel-15/Rel-16, the UE may process fewer active CSI-RS resources/ports in a slot for enhanced CSI reporting for 3GPP NR Rel-17 enhanced CSI reporting for a single DCI Multi-TRP NCJT scheme.

In some embodiments of the method 200, the maximum number of active CSI-RS resources/ports the UE can process in a slot, for 3GPP NR Rel-17 enhanced CSI reporting for a single DCI Multi-TRP NCJT scheme, may be indicated with one or more scaling factors indicating how many active CSI-RS resources/ports the UE can process in a slot for 3GPP Rel-15/Rel-16 CSI reporting in comparison to how many active CSI-RS resources/ports the UE can process in a slot for 3GPP NR Rel-17 enhanced CSI reporting for a single DCI Multi-TRP NCJT scheme, or vice versa. For example, a scaling factor of two may indicate that, for every multiple of two active CSI-RS resources/ports the UE can process in a slot for 3GPP Rel-15/Rel-16 CSI reporting, the UE can only process one active CSI-RS resources/ports in a slot for 3GPP NR Rel-17 enhanced CSI reporting for a single DCI Multi-TRP NCJT scheme. In some cases, a scaling factor may be provided for each of the following indications in the Rel-15/Rel-16 UE capability information: maxNumberSimultaneousNZP-CSI-RS-ActBWP-AllCC, totalNumberPortsSimultaneousNZP-CSI-RS-ActBWP-AllCC, maxNumberSimultaneousNZP-CSI-RS-PerCC, and totalNumberPortsSimultaneousNZP-CSI-RS-PerCC.

In accord with the method 200, the UE may also or alternatively include, in the UE capability information transmitted at 204, an indication of the maximum number of CPUs it can process in a slot. In some embodiments, the maximum number of CPUs the UE can process in a slot may be jointly indicated for both 3GPP NR Rel-17 enhanced CSI reporting for a single DCI Multi-TRP NCJT scheme and 3GPP Rel-15/Rel-16 CSI reporting. For example, the 3GPP Rel-15/Rel-16 UE capability information for CSI reporting may also indicate the maximum number of CPUs supported by the UE for 3GPP NR Rel-17 enhanced CSI reporting for a single DCI Multi-TRP NCJT scheme. That is, the 3GPP Rel-15/Rel-16 UE capability information (e.g., simultaneousCSI-ReportsPerCC and simultaneousCSI-ReportsAllCC) may also apply to 3GPP NR Rel-17 enhanced CSI reporting for a single DCI Multi-TRP NCJT scheme. In some cases, however, the enhanced CSI reporting indications may unduly limit the values of the CSI reporting indications, because the values of the enhanced CSI reporting indications may be lower than the values of the CSI reporting indications and, in such embodiments, there is no provision for separately indicating values for CSI reporting and enhanced CSI reporting.

In some embodiments of the method 200, the maximum number of CPUs the UE can process in a slot may be separately indicated for 3GPP NR Rel-17 enhanced CSI reporting for a single DCI Multi-TRP NCJT scheme and 3GPP Rel-15/Rel-16 CSI reporting. For example, the format of the 3GPP Rel-15/Rel-16 UE capability information may be used to separately indicate, in a new information element, set of information elements, or set of fields, the maximum number of CPUs that can be processed by the UE for 3GPP NR Rel-17 enhanced CSI reporting for a single DCI Multi-TRP NCJT scheme. That is, the UE capability information transmitted at 204 may include new simultaneousCSI-ReportsPerCC and simultaneousCSI-ReportsAllCC indications. In these embodiments, the 3GPP Rel-15/Rel-16 UE capability information for indicating the maximum number of CPUs supported by the UE may only apply to 3GPP Rel-15/Rel-16 CSI reporting, and the new UE capability information (for 3GPP NR Rel-17 enhanced CSI reporting for a single DCI Multi-TRP NCJT scheme) may only apply to enhanced CSI reporting. Alternatively, the new simultaneousCSI-ReportsPerCC and simultaneousCSI-ReportsAllCC indications may be used to jointly indicate the maximum number of CPUs the UE can process in a slot for both 3GPP NR Rel-17 enhanced CSI reporting for a single DCI Multi-TRP NCJT scheme and 3GPP Rel-15/Rel-16 CSI reporting.

In some embodiments of the method 200, the maximum number of CPUs the UE can process in a slot may be indicated as at least one combination of a first maximum number of CPUs the UE can process in a slot for 3GPP NR Rel-17 enhanced CSI reporting for a single DCI Multi-TRP NCJT scheme, and a second maximum number of CPUs the UE can process in a slot, in combination with the first number, for 3GPP Rel-15/Rel-16 CSI reporting. A combination may be provided for each of new simultaneousCSI-ReportsPerCC and simultaneousCSI-ReportsAllCC indications. For example, for a new simultaneousCSI-ReportsPerCC indication, the UE may include, in the UE capability information transmitted at 204, the following list:
Maximum of 16 CPUs for Rel-15/16, and maximum of 0 CPUs for Rel-17;
Maximum of 48 CPUs for Rel-15/16, and maximum of 8 CPUs for Rel-17;
Maximum of 32 CPUs for Rel-15/16, and maximum of 16 CPUs for Rel-17;
Maximum of 16 CPUs for Rel-15/16, and maximum of 24 CSI-RS CPUs for Rel-17; and
Maximum of 0 CPUs for Rel-15/16, and maximum of 32 CPUs for Rel-17.

The above list shows that, in comparison to CSI reporting for 3GPP Rel-15/Rel-16, the UE may process fewer CPUs for enhanced CSI reporting in a slot for 3GPP NR Rel-17 enhanced CSI reporting for a single DCI Multi-TRP NCJT scheme.

In some embodiments of the method 200, the maximum number of CPUs the UE can process in a slot, for 3GPP NR Rel-17 enhanced CSI reporting for a single DCI Multi-TRP NCJT scheme, may be indicated with one or more scaling factors indicating how many CPUs the UE can process in a slot for 3GPP Rel-15/Rel-16 CSI reporting in comparison to how many CPUs the UE can process in a slot for 3GPP NR Rel-17 enhanced CSI reporting for a single DCI Multi-TRP NCJT scheme. For example, a scaling factor of two may indicate that, for every multiple of two CPUs the UE can process in a slot for 3GPP Rel-15/Rel-16 CSI reporting, the UE can only process one CPU in a slot for 3GPP NR Rel-17 enhanced CSI reporting for a single DCI Multi-TRP NCJT scheme. In some cases, a scaling factor may be provided for each of the following indications in the Rel-15/Rel-16 UE capability information: simultaneousCSI-ReportsPerCC and simultaneousCSI-ReportsAllCC.

In some embodiments of the method 200, the maximum number of CPUs the UE can process in a slot, for 3GPP NR Rel-17 enhanced CSI reporting for a single DCI Multi-TRP NCJT scheme, may be indicated as a maximum number of CPUs the UE can process in a slot across all component carriers (CCs) in use by the UE. In these embodiments, the indication of the maximum number of CPUs the UE can process in a slot across all CCs in use by the UE may be reported per band combination (BC). In cases where a BC contains both Frequency Range 1 (FR1) and Frequency Range 2 (FR2) bands, the UE may report the maximum number of CPUs the UE can process across all CCs separately, for FR1 and FR2.

In accord with the method 200, the UE may also or alternatively include, in the UE capability information transmitted at 204, an indication of a CSI report UE processing complexity envelope for 3GPP NR Rel-17 enhanced CSI reporting for a single DCI Multi-TRP NCJT scheme. In terms of resource configuration, the UE may report, for the CSI report UE processing complexity envelope, a list of combinations. One or multiple combinations may be reported, such as up to 16 combinations in one example. In some embodiments, and for each combination, the UE may report: a maximum number of ports that can be configured per CSI-RS resource for Single-TRP measurement; a maximum number of total CSI-RS ports for Single-TRP measurement; a maximum number of CSI-RS resources for Single-TRP measurement; a maximum number of ports that can be configured per CSI-RS resource for Multi-TRP measurement; a maximum number of total CSI-RS ports for Multi-TRP measurement; and a maximum number of CSI-RS resources for Multi-TRP measurement. In some embodiments, and for each combination, the UE may report: a maximum number of ports that can be configured per CSI-RS resource for either Single-TRP or Multi-TRP measurement; a maximum number of total CSI-RS ports for either Single-TRP or Multi-TRP measurement; and a maximum number of CSI-RS resources for either Single-TRP or Multi-TRP measurement.

In some embodiments of the method 200, the indication of the CSI report UE processing complexity envelope for 3GPP NR Rel-17 enhanced CSI reporting for a single DCI Multi-TRP NCJT scheme may include, in terms of resource configuration, a supported CSI-RS resource list (e.g., supportedCSI-RS-ResourceList). The list may in some cases be the list reported for Type I single panel codebook for Rel-15 capability, or in other cases may be a separate list reported for 3GPP NR Rel-17 enhanced CSI reporting for a single DCI Multi-TRP NCJT scheme. In some cases, a separate list may follow the same format (or a similar format) as the Rel-15 list reported for Type I single panel codebook.

The UE capability information transmitted at 204 may include any or all of the UE capability information described herein, in addition to other UE capability information.

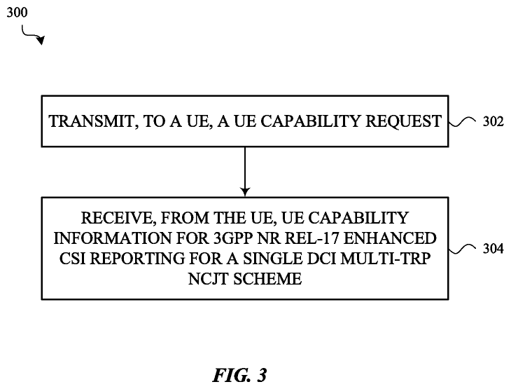

FIG. 3 shows an example method 300 of a network (e.g., a RAN (e.g., a base station of a RAN) or a CN), which method 300 may be used to receive UE capability information from a UE in accord with the flow diagram described with reference to FIG. 1.

At block 302, the method 300 may include transmitting, to a UE, a UE capability request.

At block 304, the method 300 may include receiving, from the UE, UE capability information for 3GPP NR Rel-17 enhanced CSI reporting for a single DCI Multi-TRP NCJT scheme.

In accord with the method 300, the network may receive, in the UE capability information transmitted at 304, an indication of the UE's CSI reporting capability, a number of active CSI-RS resources/ports that can be processed in a slot, a number of CPUs that can be processed, and/or a CSI report UE processing complexity envelope.

Embodiments contemplated herein include an apparatus having means to perform one or more elements of the flow or method 100, 200, or 300. In the context of flow or method 100 or 200, this apparatus may be, for example, an apparatus of a UE (such as a wireless device 502 that is a UE, as described herein). In the context of flow or method 100 or 300, this apparatus may be, for example, an apparatus of a base station (such as a network device 520 that is a base station, as described herein).

Embodiments contemplated herein include one or more non-transitory computer-readable media storing instructions to cause an electronic device, upon execution of the instructions by one or more processors of the electronic device, to perform one or more elements of the flow or method 100, 200, or 300. In the context of flow or method 100 or 200, this non-transitory computer-readable media may be, for example, a memory of a UE (such as a memory 506 of a wireless device 502 that is a UE, as described herein). In the context of flow or method 100 or 300, this non-transitory computer-readable media may be, for example, a memory of a base station (such as a memory 524 of a network device 520 that is a base station, as described herein).

Embodiments contemplated herein include an apparatus having logic, modules, or circuitry to perform one or more elements of the flow or method 100, 200, or 300. In the context of flow or method 100 or 200, this apparatus may be, for example, an apparatus of a UE (such as a wireless device 502 that is a UE, as described herein). In the context of flow or method 100 or 300, this apparatus may be, for example, an apparatus of a base station (such as a network device 520 that is a base station, as described herein).

Embodiments contemplated herein include an apparatus having one or more processors and one or more computer-readable media, using or storing instructions that, when executed by the one or more processors, cause the one or more processors to perform one or more elements of the method 100, 200, or 300. In the context of flow or method 100 or 200, this apparatus may be, for example, an apparatus of a UE (such as a wireless device 502 that is a UE, as described herein). In the context of flow or method 100 or 300, this apparatus may be, for example, an apparatus of a base station (such as a network device 520 that is a base station, as described herein).

Embodiments contemplated herein include a signal as described in or related to one or more elements of the flow or method 100, 200, or 300.

Embodiments contemplated herein include a computer program or computer program product having instructions, wherein execution of the program by a processor causes the processor to carry out one or more elements of the flow or method 100, 200, or 300. In the context of flow or method 100 or 200, the processor may be a processor of a UE (such as a processor(s) 504 of a wireless device 502 that is a UE, as described herein), and the instructions may be, for example, located in the processor and/or on a memory of the UE (such as a memory 506 of a wireless device 502 that is a UE, as described herein). In the context of flow or method 100 or 300, the processor may be a processor of a base station (such as a processor(s) 522 of a network device 520 that is a base station, as described herein), and the instructions may be, for example, located in the processor and/or on a memory of the base station (such as a memory 524 of a network device 520 that is a base station, as described herein).

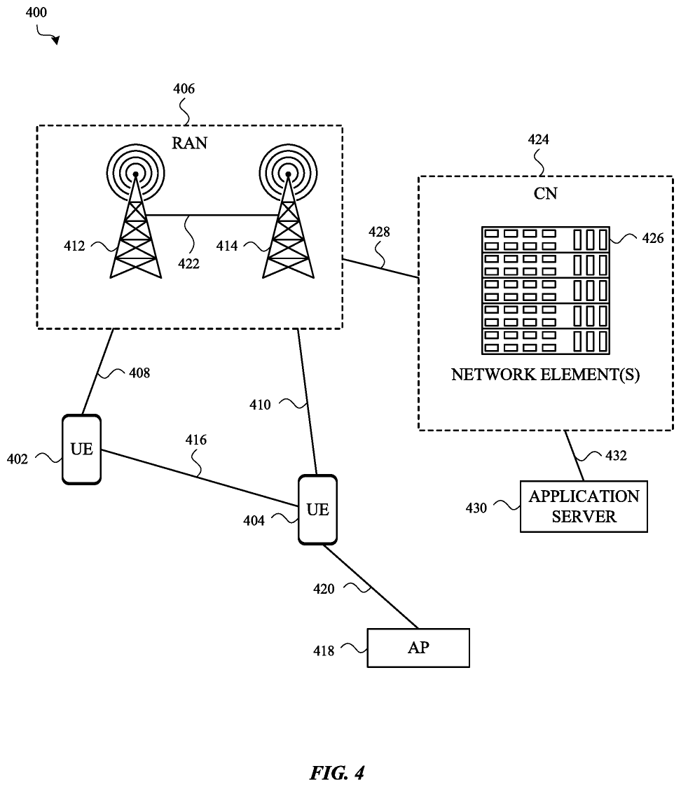

FIG. 4 illustrates an example architecture of a wireless communication system 400, according to embodiments disclosed herein. The following description is provided for an example wireless communication system 400 that operates in conjunction with the LTE system standards and/or 5G or NR system standards as provided by 3GPP technical specifications.

As shown by FIG. 4, the wireless communication system 400 includes UE 402 and UE 404 (although any number of UEs may be used). In this example, the UE 402 and the UE 404 are illustrated as smartphones (e.g., handheld touchscreen mobile computing devices connectable to one or more cellular networks), but may also comprise any mobile or non-mobile computing device configured for wireless communication.

The UE 402 and UE 404 may be configured to communicatively couple with a RAN 406. In embodiments, the RAN 406 may be NG-RAN, E-UTRAN, etc. The UE 402 and UE 404 utilize connections (or channels) (shown as connection 408 and connection 410, respectively) with the RAN 406, each of which comprises a physical communications interface. The RAN 406 can include one or more base stations, such as base station 412 and base station 414, that enable the connection 408 and connection 410.

In this example, the connection 408 and connection 410 are air interfaces to enable such communicative coupling, and may be consistent with RAT(s) used by the RAN 406, such as, for example, an LTE and/or NR.

In some embodiments, the UE 402 and UE 404 may also directly exchange communication data via a sidelink interface 416. The UE 404 is shown to be configured to access an access point (shown as AP 418) via connection 420. By way of example, the connection 420 can comprise a local wireless connection, such as a connection consistent with any IEEE 802.11 protocol, wherein the AP 418 may comprise a Wi-Fi® router. In this example, the AP 418 may be connected to another network (for example, the Internet) without going through a CN 424.

In embodiments, the UE 402 and UE 404 can be configured to communicate using orthogonal frequency division multiplexing (OFDM) communication signals with each other or with the base station 412 and/or the base station 414 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 412 or base station 414 may be implemented as one or more software entities running on server computers as part of a virtual network. In addition, or in other embodiments, the base station 412 or base station 414 may be configured to communicate with one another via interface 422. In embodiments where the wireless communication system 400 is an LTE system (e.g., when the CN 424 is an EPC), the interface 422 may be an X2 interface. The X2 interface may be defined between two or more base stations (e.g., two or more eNBs and the like) that connect to an EPC, and/or between two eNBs connecting to the EPC. In embodiments where the wireless communication system 400 is an NR system (e.g., when CN 424 is a 5GC), the interface 422 may be an Xn interface. The Xn interface is defined between two or more base stations (e.g., two or more gNBs and the like) that connect to 5GC, between a base station 412 (e.g., a gNB) connecting to 5GC and an eNB, and/or between two eNBs connecting to 5GC (e.g., CN 424).

The RAN 406 is shown to be communicatively coupled to the CN 424. The CN 424 may comprise one or more network elements 426, which are configured to offer various data and telecommunications services to customers/subscribers (e.g., users of UE 402 and UE 404) who are connected to the CN 424 via the RAN 406. The components of the CN 424 may be implemented in one physical device or separate physical devices including components to read and execute instructions from a machine-readable or computer-readable medium (e.g., a non-transitory machine-readable storage medium).

In embodiments, the CN 424 may be an EPC, and the RAN 406 may be connected with the CN 424 via an S1 interface 428. In embodiments, the S1 interface 428 may be split into two parts, an S1 user plane (S1-U) interface, which carries traffic data between the base station 412 or base station 414 and a serving gateway (S-GW), and the S1-MME interface, which is a signaling interface between the base station 412 or base station 414 and mobility management entities (MMEs).

In embodiments, the CN 424 may be a 5GC, and the RAN 406 may be connected with the CN 424 via an NG interface 428. In embodiments, the NG interface 428 may be split into two parts, an NG user plane (NG-U) interface, which carries traffic data between the base station 412 or base station 414 and a user plane function (UPF), and the S1 control plane (NG-C) interface, which is a signaling interface between the base station 412 or base station 414 and access and mobility management functions (AMFs).

Generally, an application server 430 may be an element offering applications that use internet protocol (IP) bearer resources with the CN 424 (e.g., packet switched data services). The application server 430 can also be configured to support one or more communication services (e.g., VOIP sessions, group communication sessions, etc.) for the UE 402 and UE 404 via the CN 424. The application server 430 may communicate with the CN 424 through an IP communications interface 432.

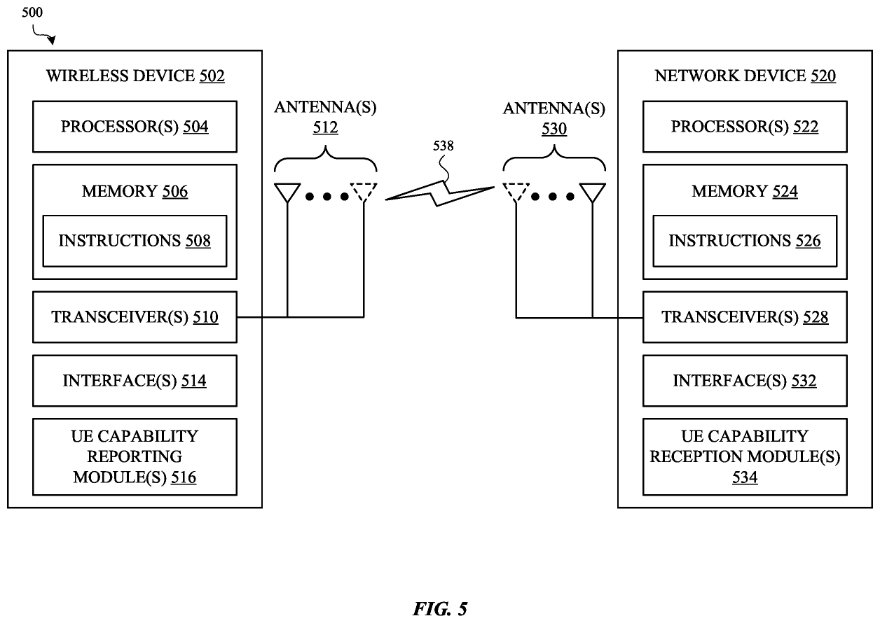

FIG. 5 illustrates a system 500 for performing signaling 538 between a wireless device 502 and a network device 520, according to embodiments disclosed herein. The system 500 may be a portion of a wireless communications system as herein described. The wireless device 502 may be, for example, a UE of a wireless communication system. The network device 520 may be, for example, a base station (e.g., an eNB or a gNB) of a wireless communication system.

The wireless device 502 may include one or more processor(s) 504. The processor(s) 504 may execute instructions such that various operations of the wireless device 502 are performed, as described herein. The processor(s) 504 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 502 may include a memory 506. The memory 506 may be a non-transitory computer-readable storage medium that stores instructions 508 (which may include, for example, the instructions being executed by the processor(s) 504). The instructions 508 may also be referred to as program code or a computer program. The memory 506 may also store data used by, and results computed by, the processor(s) 504.

The wireless device 502 may include one or more transceiver(s) 510 that may include radio frequency (RF) transmitter and/or receiver circuitry that use the antenna(s) 512 of the wireless device 502 to facilitate signaling (e.g., the signaling 538) to and/or from the wireless device 502 with other devices (e.g., the network device 520) according to corresponding RATs.

The wireless device 502 may include one or more antenna(s) 512 (e.g., one, two, four, or more). For embodiments with multiple antenna(s) 512, the wireless device 502 may leverage the spatial diversity of such multiple antenna(s) 512 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 502 may be accomplished according to precoding (or digital beamforming) that is applied at the wireless device 502 that multiplexes the data streams across the antenna(s) 512 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 502 may implement analog beamforming techniques, whereby phases of the signals sent by the antenna(s) 512 are relatively adjusted such that the (joint) transmission of the antenna(s) 512 can be directed (this is sometimes referred to as beam steering).

The wireless device 502 may include one or more interface(s) 514. The interface(s) 514 may be used to provide input to or output from the wireless device 502. For example, a wireless device 502 that is a UE may include interface(s) 514 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 510/antenna(s) 512 already described) that allow for communication between the UE and other devices and may operate according to known protocols (e.g., Wi-Fi®, Bluetooth®, and the like).

The wireless device 502 may include a UE capability reporting module 516. The UE capability reporting module 516 may be implemented via hardware, software, or combinations thereof. For example, the UE capability reporting module 516 may be implemented as a processor, circuit, and/or instructions 508 stored in the memory 506 and executed by the processor(s) 504. In some examples, the UE capability reporting module 516 may be integrated within the processor(s) 504 and/or the transceiver(s) 510. For example, the UE capability reporting module 516 may be implemented by a combination of software components (e.g., executed by a DSP or a general processor) and hardware components (e.g., logic gates and circuitry) within the processor(s) 504 or the transceiver(s) 510.

The UE capability reporting module 516 may be used for various aspects of the present disclosure, for example, aspects of FIG. 1 through FIG. 3. The UE capability reporting module 516 may be configured to, for example, report UE capability information to another device (e.g., the network device 520).

The network device 520 may include one or more processor(s) 522. The processor(s) 522 may execute instructions such that various operations of the network device 520 are performed, as described herein. The processor(s) 504 may include one or more baseband processors implemented using, for example, a CPU, a DSP, an ASIC, a controller, an FPGA device, another hardware device, a firmware device, or any combination thereof configured to perform the operations described herein.

The network device 520 may include a memory 524. The memory 524 may be a non-transitory computer-readable storage medium that stores instructions 526 (which may include, for example, the instructions being executed by the processor(s) 522). The instructions 526 may also be referred to as program code or a computer program. The memory 524 may also store data used by, and results computed by, the processor(s) 522.

The network device 520 may include one or more transceiver(s) 528 that may include RF transmitter and/or receiver circuitry that use the antenna(s) 530 of the network device 520 to facilitate signaling (e.g., the signaling 538) to and/or from the network device 520 with other devices (e.g., the wireless device 502) according to corresponding RATs.

The network device 520 may include one or more antenna(s) 530 (e.g., one, two, four, or more). In embodiments having multiple antenna(s) 530, the network device 520 may perform MIMO, digital beamforming, analog beamforming, beam steering, etc., as has been described.

The network device 520 may include one or more interface(s) 532. The interface(s) 532 may be used to provide input to or output from the network device 520. For example, a network device 520 that is a base station may include interface(s) 532 made up of transmitters, receivers, and other circuitry (e.g., other than the transceiver(s) 528 and antenna(s) 530 already described) that enables the base station to communicate with other equipment in a core network, and/or that enables the base station to communicate with external networks, computers, databases, and the like for purposes of operations, administration, and maintenance of the base station or other equipment operably connected thereto.

The network device 520 may include a UE capability reception module 534. The UE capability reception module 534 may be implemented via hardware, software, or combinations thereof. For example, the UE capability reception module 534 may be implemented as a processor, circuit, and/or instructions 526 stored in the memory 524 and executed by the processor(s) 522. In some examples, the UE capability reception module 534 may be integrated within the processor(s) 522 and/or the transceiver(s) 528. For example, the UE capability reception module 534 may be implemented by a combination of software components (e.g., executed by a DSP or a general processor) and hardware components (e.g., logic gates and circuitry) within the processor(s) 522 or the transceiver(s) 528.

The UE capability reception module 534 may be used for various aspects of the present disclosure, for example, aspects of FIG. 1 through FIG. 3. The UE capability reception module 534 may be configured to, for example, receive UE capability information from another device (e.g., the wireless device 502).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a transceiver; and
a processor configured to,
receive, via the transceiver, a UE capability request; and
transmit, via the transceiver and in response to the UE capability request, UE capability information for 3rd Generation Partnership Project (3GPP) new radio (NR) Release 17 (Rel-17) enhanced channel state information (CSI) reporting for a single downlink control information (DCI) multiple transmission and reception point (Multi-TRP) non-coherent joint transmission (NCJT) scheme.

2. The UE of claim 1, wherein the UE capability information includes an indication of whether the UE supports an enhanced CSI reporting of:
Mode 1 X=0;
Mode 1 X=1;
Mode 1 X=2; or
Mode 2.

3. The UE of claim 1, wherein:
the UE capability information includes an indication that the UE supports an enhanced CSI reporting Mode 1 X=n, where n is an integer greater than or equal to 1; and
the UE is configured to support each CSI reporting Mode 1 X≤n.

4. The UE of claim 1, wherein:
the UE is configured to support an enhanced CSI reporting Mode 1 X≥1; and
the UE capability information includes an indication that the UE supports an enhanced CSI reporting Mode 1 X=n, where n≥1.

5. The UE of claim 1, wherein:
the UE is configured to support only an enhanced CSI reporting Mode 1 X=0 and
the UE capability information includes an indication that a maximum Kₛ supported by the UE is 0, where Kₛ=K₁+K₂, K₁ is a number of NZP CSI-RS resources for a first Single-TRP measurement of a first TRP in a Multi-TRP, and K₂ is a number of NZP CSI-RS resources for a second Single-TRP measurement of a second TRP in the Multi-TRP.

6. The UE of claim 1, wherein:
enhanced CSI reporting Mode 1 is a basic feature;
the UE capability information includes an indication that the UE supports enhanced CSI reporting Mode 2; and
transmission of the UE capability information including the indication that the UE supports enhanced CSI reporting Mode 2 indicates that the UE also supports at least one enhanced CSI reporting Mode 1 X=n.

7. The UE of claim 1, wherein:
the UE capability information includes an indication that the UE supports enhanced CSI reporting; and
transmission of the UE capability information including the indication that the UE supports an enhanced CSI reporting mode indicates that the UE supports at least one enhanced CSI reporting Mode 1 X=n and enhanced CSI reporting Mode 2.

8. The UE of claim 1, wherein the UE capability information includes an indication of a maximum number of active CSI-RS resources/ports the UE can process in a slot.

9. The UE of claim 8, wherein the processor is configured to indicate the maximum number of active CSI-RS resources/ports the UE can process, for 3GPP NR Rel-17 enhanced CSI reporting for a single DCI Multi-TRP NCJT scheme, using UE capability information for 3GPP Rel-15/Rel-16 CSI reporting.

10. The UE of claim 8, wherein the processor is configured to indicate the maximum number of active CSI-RS resources/ports the UE can process, for 3GPP NR Rel-17 enhanced CSI reporting for a single DCI Multi-TRP NCJT scheme, using a set of one or more information elements separate from UE capability information for 3GPP Rel-15/Rel-16 CSI reporting.

11. The UE of claim 8, wherein the processor is configured to indicate the maximum number of active CSI-RS resources/ports the UE can process in the slot as at least one combination of:
a first maximum number of active CSI-RS resources/ports the UE can process in a slot for 3GPP NR Rel-17 enhanced CSI reporting for a single DCI Multi-TRP NCJT scheme; and
a second maximum number of active CSI-RS resources/ports the UE can process in a slot, in combination with the first maximum number, for 3GPP Rel-15/Rel-16 CSI reporting.

12. The UE of claim 8, wherein the processor is configured to indicate the maximum number of active CSI-RS resources/ports the UE can process in a slot with a scaling factor indicating how many active CSI-RS resources/ports the UE can process in a slot for 3GPP Rel-15/Rel-16 CSI reporting in comparison to how many active CSI-RS resources/ports the UE can process in a slot for 3GPP NR Rel-17 enhanced CSI reporting for a single DCI Multi-TRP NCJT scheme.

13. The UE of claim 1, wherein the UE capability information includes an indication of a maximum number of CSI processing units (CPUs) the UE can process in a slot.

14. The UE of claim 13, wherein the processor is configured to indicate the maximum number of CPUs the UE can process in a slot, for 3GPP NR Rel-17 enhanced CSI reporting for a single DCI Multi-TRP NCJT scheme, using UE capability information for 3GPP Rel-15/Rel-16 CSI reporting.

15. The UE of claim 13, wherein the processor is configured to indicate the maximum number of CPUs the UE can process in a slot, for 3GPP NR Rel-17 enhanced CSI reporting for a single DCI Multi-TRP NCJT scheme, using a set of one or more information elements separate from UE capability information for 3GPP Rel-15/Rel-16 CSI reporting.

16. The UE of claim 13, wherein the processor is configured to indicate the maximum number of CPUs the UE can process in a slot as at least one combination of:
a first maximum number of CPUs the UE can process in a slot for 3GPP NR Rel-17 enhanced CSI reporting for a single DCI Multi-TRP NCJT scheme; and
a second maximum number of CPUs the UE can process in a slot, in combination with the first maximum number, for 3GPP Rel-15/Rel-16 CSI reporting.

17. The UE of claim 13, wherein the processor is configured to indicate the maximum number of CPUs the UE can process in a slot with a scaling factor indicating how many CPUs the UE can process in a slot for 3GPP Rel-15/Rel-16 CSI reporting in comparison to how many CPUs the UE can process in a slot for 3GPP NR Rel-17 enhanced CSI reporting for a single DCI Multi-TRP NCJT scheme.

18. The UE of claim 1, wherein:
the processor is configured to indicate the maximum number of CPUs the UE can process in a slot as a maximum number of CPUs the UE can process in a slot across all component carriers in use by the UE; and
the maximum number of CPUs the UE can process in a slot across all component carriers in use by the UE is reported per band combination.

19. The UE of claim 1, wherein:
the UE capability information includes an indication of a CSI report UE processing complexity envelope; and
the CSI report UE processing complexity envelope includes, in terms of resource configuration, a list of one or more combinations, each combination including,
a maximum number of ports that can be configured per CSI-RS resource for Single-TRP measurement;
a maximum number of total CSI-RS ports for Single-TRP measurement;
a maximum number of CSI-RS resources for Single-TRP measurement;
a maximum number of ports that can be configured per CSI-RS resource for Multi-TRP measurement;
a maximum number of total CSI-RS ports for Multi-TRP measurement; and
a maximum number of CSI-RS resources for Multi-TRP measurement.

20. The UE of claim 1, wherein:
the UE capability information includes an indication of a CSI report UE processing complexity envelope; and
the CSI report UE processing complexity envelope includes, in terms of resource configuration, a list of one or more combinations, each combination including,
a maximum number of ports that can be configured per CSI-RS resource for either Single-TRP or Multi-TRP measurement;
a maximum number of total CSI-RS ports for either Single-TRP or Multi-TRP measurement; and
a maximum number of CSI-RS resources for either Single-TRP or Multi-TRP measurement.
